(19) United States
(12) Patent Application Publication
(10) Pub. No.: US 2020/0387611 A1
(43) Pub. Date: Dec. 10, 2020

(54) MANAGEABILITY ENGINE AND AUTOMATIC FIRMWARE VALIDATION

(71) Applicants: Vincent J. ZIMMER, Federal Way, WA (US); Intel Corporation, Santa Clara, CA (US)

(72) Inventors: Jiewen YAO, Shanghai (CN); Vincent J. ZIMMER, Federal Way, WA (US)

(21) Appl. No.: 16/764,588

(22) PCT Filed: Dec. 22, 2017
(86) PCT No.: PCT/CN2017/117970

§ 371 Date: May 15, 2020

(51) Int. Cl. G06F 21/57; G06F 8/65

(52) U.S. Cl. CPC G06F 21/572; G06F 2221/033; G06F 21/577; G06F 8/65

(57) ABSTRACT

Malicious attacks have moved from higher level virus attacks on software and data files operating on a device, to subverting the firmware underlying the device, where the firmware will compromise operation of the device even after attempts to remove the virus, unwanted programs, or other activity due to the subversion. If the firmware is compromised then even a clean reinstall of all software and/or services on the device may only result in a clean device that is then subsequently compromised again. Although device manufacturers may update a firmware to remove the vulnerability, there remains a problem in getting users to actually perform the update. To facilitate device security, a database or databases of firmware may be maintained where their status of vulnerable (bad) or not (good) is maintained and various options are presented for scanning firmware for vulnerabilities, out of band or manually, and pulling/pushing updates as desired to automatically update a device or prompt a user for updating. Updates may be mandatory per a policy and/or controlled by user preference. Looking for vulnerabilities may be device driven, or managed by an external entity. As new vulnerabilities are discovered, existing firmware may be checked for the vulnerability, and if found, devices having vulnerable firmware may be updated. New firmware may be recorded in the database(s) and the database(s) periodically scanned for vulnerabilities.

### TECHNICAL FIELD

The present disclosure relates to manageability engines, and more particularly, to automatically validating machine firmware.

### BACKGROUND AND DESCRIPTION OF RELATED ART

It will be appreciated as soon as there were computing devices, there was someone trying to hack them. Sometimes for positive reasons, sometimes for negative reasons, but regardless of the reasons, devices are always subject to attack. An example of a positive reason, is someone might try to extend the life of an old device by replacing its default software or firmware with something new/streamlined/improved, or someone might try to make software compatible with a device that ordinarily would not run it. A well-known negative reason to hack a device is to damage the device, or perhaps to put ransomware in place, and this can be done with a virus that changes key elements of a system. Typically, viruses attack operating systems and other software executing in a device on top of the hardware, and to counter them people have been using various antivirus protection software. Virus and anti-virus software are in a constant battle for control of the device. Occasionally the virus wins, and sometimes the only counter-offensive is a system wipe and start over. However, that seemingly simple solution is sometimes unavailable.

To initiate a system wipe and start over, one may reboot the device and install, for example, a clean copy of an operating system. Rebooting may cause a device to execute some sort of bootstrapping code, e.g., “EFI” code (Extensible Firmware Interface), or Unified EFI (UEFI) code (which replaced EFI), which includes instructions that may refer to or be part a partition or specific location in a boot device, e.g., a hard disk, which in turn may execute, for example, the installer to load the new operating system. The UEFI Specification was primarily intended for the next generation of IA architecture-based computers, and is an outgrowth of the “Intel® Boot Initiative” (IBI) program that began in 1998. Intel's original version of this specification was publicly named EFI, ending with the EFI 1.10 version. In 2005, The Unified EFI Forum was formed as an industry-wide organization to promote adoption and continue the development of the EFI Specification. Using the EFI 1.10 Specification as the starting point, this industry group released the following specifications, renamed Unified EFI. The current version of the UEFI Specification can be found at the UEFI web site at Internet uniform resource locator (URL) www.uefi.org.

Generally speaking, the UEFI Specification defines an interface between an operating system and platform firmware. The interface consists of data, tables, etc. containing platform-related information, boot service calls, and runtime service calls that are available to the operating system and its loader. These provide a standard environment for initial power-on of a machine, booting an operating system, and running pre-boot applications, of which one may be to install the new operating system. However, attackers are starting to compromise firmware used to start a system, so that trying to wipe a system and put a clean installation in place will result in a clean system that then becomes compromised again because underlying hardware/firmware, being corrupted, will reintroduce vulnerabilities into the newly installed operating system. Already various firmware vulnerabilities have been exposed and used to subvert the hardware in a system. See, for example, the Lenovo ThinkPwn subversion located at Internet URL github.com/Cr4sh/ThinkPwn.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary environment 100.

FIG. 2 illustrates an exemplary environment illustrating a computer device 200, in accordance with various embodiments.

FIG. 3 illustrates an exemplary environment 300 illustrating a storage medium.

FIG. 4 illustrates an exemplary environment 400.

FIG. 5 illustrates an exemplary environment 500.

FIG. 6 illustrates an exemplary environment 600.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations do not have to be performed in the order of presentation. Operations described may be performed in a different order than the described embodiment. Various additional operations may be performed and/or described operations may be omitted in additional embodiments. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are considered synonymous.

As used herein, the term “circuitry” or “circuit” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, processor, microprocessor, programmable gate array (PGA), field programmable gate array (FPGA), digital signal processor (DSP) and/or other suitable components that provide the described functionality. Note while this disclosure may refer to a processor in the singular, this is for expository convenience only, and one skilled in the art will appreciate multiple processors, processors with multiple cores, virtual processors, etc., may be employed to perform the disclosed embodiments.

It is assumed the reader is familiar EFI and UEFI. In this description the terms “boot” or “booting” refer to using any technique or combination of techniques, EFI, UEFI, boot sector, boot manager, etc. to access a memory or other storage area/region containing code which may initialize the startup of a machine, such as a cell phone, computer, laptop computer, or any other electronic machine or device. When a device is powered on or otherwise set to a boot condition, a boot manager or other initial controlling operation checks a boot configuration, if necessary, and based on boot settings, loads into memory and then executes a specified OS loader, operating system kernel, bootstrap program, etc. A boot configuration may be defined by variables stored in a nonvolatile memory or storage, such as nonvolatile ram (NVRAM), and identify OS loaders and OS kernels locations. It will be appreciated by one skilled in the art that the present disclosure is not limited to EFI/UEFI, they are presented for exemplary purposes and the present disclosure is applicable to other technology and/or other host-based firmware such as built via PC/AT BIOS, Intel Firmware Support Package (see Internet URL www.intel.com/fsp), coreboot (see Internet URL coreboot.org), U-boot (see Internet URL www.denx.de/wiki/U-Boot), ARM Trusted Firmware (see Internet URL github.com/ARM-software/arm-trusted-firmware), etc.

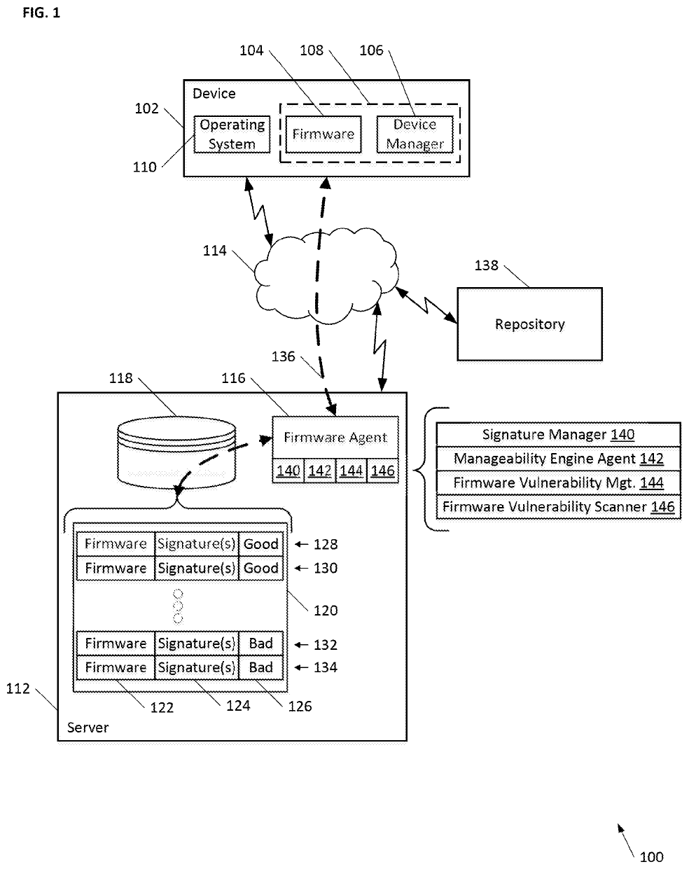

For example, assume system code (e.g., code to control boot or low-level device operation) is in a BIOS (Basic Input/Output System), EFI, UEFI, etc. located in a flash region of memory, e.g., in a nonvolatile memory (NVRAM). The device may be any device, such as a cell phone, tablet, computer, etc. When a virus attacks the device and alters the content of the system code, as discussed above, ordinarily a wipe of the device will not help since the problem is now in the hardware needed to initially start the device. To address this, a firmware vulnerability database may be created to store all known firmware security issues. Depending on the device, the database may be stored in whole or in part locally (perhaps just bad firmware signatures), or on a remote server (see, e.g., FIG. 1), or a combination of the two. For example, since devices are increasingly becoming “always connected” a local database may be augmented with remote server resources, or locally updated (at least periodically) before initialization of a device is allowed. With this database a device's firmware(s) may be inspected for vulnerabilities automatically, e.g., by way of a manageability engine (ME), such as in the Intel® AMT which is part of the Intel® vPro™ technology offering. Platforms equipped with Intel AMT can be managed remotely, regardless of its power state or if it has a functioning OS or not. See for example the Internet URL software.intel.com/en-us/articles/getting-started-with-intel-active-management-technology-amt. This is one exemplary environment that may be used, pre-boot, to validate device hardware. If validation fails, then an updated uncorrupted firmware may be accessed and provisioned on the affected device.

FIG. 1 illustrates an exemplary environment 100 illustrating a device 102, such as a cellular phone, computer, etc., any device that may contain a firmware 104 that may be compromised. In the illustrated embodiment, the device may contain a firmware manager 106 which may operate prior to execution of the firmware, e.g. when the device is booted, restarted, initialized, etc. The firmware and device manager are illustrated as being combined in a dashed box 108. The dashed box 108 is to indicate the circuitry and/or code for the device manager may be part of the firmware, or they may be separate components of the device. Generally speaking it is expected that at least initially the device is controlled by the device manager. In one embodiment, the device manager is a manageability engine (ME), such as one provided by Intel® Corporation as part of its Intel Active Management Technology (AMT), which is a hardware/firmware technology for out-of-band device management. In the illustrated embodiment the device manager may automatically manage the firmware, including validating the correctness of the firmware, and automatically updating the firmware if needed.

As discussed above, firmware is now being targeted and compromised. To address problems such as the ThinkPwn example, firmware engineer teams invested considerable time and resources analyzing the exploit and identifying many different impacted hardware configurations and devices. The lengthy amount of time required was in part due to the sheer number of possible firmware trees, builds, device combinations, etc. where each of these may be based in different geographies, and each impacted entity needs to have experts available to investigate, analyze the problem, determine a general solution, and then apply (or make available) that solution to their specific hardware environment across all deployments. For example, when Intel® identifies a firmware concern, after production codes, devices, etc. are fixed, Intel® publishes an updated firmware and customers may elect to download the fix and update their devices. Many customers, however, remain unaware of the updates, or are unwilling to risk “bricking” their device by trying an update they feel may fail. Thus, even if the complex path required to fix all of the various firmware impacted by a virus is traversed by a company, it may nonetheless result in a solution that customers do not apply. To address this, it would be helpful if need for a firmware update was automatically identified, retrieved, and applied, without requiring user intervention. It will be appreciated a user may elect less automation, such as identify, retrieve, and prepare an update for installation and prompt the user to proceed.

To help reduce the workload for identifying needed updates, and to assist with automating device updates since users may not apply them, in the illustrated embodiment, a device 102 may be in communication with a server 112 though a data channel, which may be any form of network(s) 114, such as the Internet, cellular network, etc. (other network examples are discussed herein). It will be appreciated the server may contain hardware and/or software components, such as a firmware agent 116, which interacts with a database 118 that may store at least data 120 including a firmware copy 122, one or more signature(s) 124 to identify a specific firmware and/or specific vulnerability, and a status 126, e.g., is the particular firmware good or bad. Thus for example, the first part of the database, as illustrated, identifies firmware 128, 130 currently known to be good, while elsewhere the database identifies firmware 132, 134 currently known to be bad, e.g., vulnerable to some exploit. The signature 124 may be any data that may at least relatively uniquely identify the specific firmware or portion of a firmware. Cryptographic signing, may, for example, be used to determine a signature for a firmware or portion thereof. Although only one database is shown, and that the database is illustrated as containing both good and bad firmware in a particular illustrated order, it will be appreciated there may be multiple databases storing various different data that are used to operate as described herein. The illustrated database is simply to present the concept that the data is stored and may be reviewed, analyzed, etc. and any known or future information storage/retrieval system, whether local, remote or distributed, may be used.

The device manager 106 may communicate with the firmware agent 116 over a data channel 136, such as may be through the illustrated network 114. The device manager may determine a signature for its firmware or portion thereof, and provide it to the firmware agent, which may then perform a lookup in the database 118 to see whether the firmware is currently believed to be good or bad. If the device manager had, for example, interrupted a device boot to contact the firmware agent, if the firmware is believed to be good, the device manager may then allow the boot to continue. If the device manager is instead operating as an OOB task, or one in parallel to other operations, such as power-on operations, if the firmware is believed to be good then the device manager may do nothing. If the firmware is believed to be bad, boot-up might be interrupted and the device manager may require updating (such as to comply with an organization/IT policy), inquire whether to update, defer updating, boot into a “safe mode”, etc. Depending on policy and criticalness of the issue, boot may be allowed notwithstanding determining there's a problem to be addressed. If the device manager is operating OOB, a device may have already booted up, and it will be appreciated the device manager may trigger an interrupt or otherwise indicate, for example, to the device's operating system 110 that an action (e.g., update) is required to be taken. The operating system may then determine how to address the issue, such as shutdown and reboot into device manager control. It will be appreciated the “bad” 126 is a simplistic designation for discussion purposes and more detailed values may be used, including designating an issue severity that may affect the response to an alert. For example, certain critical vulnerabilities may require immediate shutdown and update, e.g., without allowing the operating system to shut itself down first.

When the device manager 106 provides a signature for the firmware 104 to the firmware agent 116, if the firmware agent does not locate the firmware in the database 118, such as when there is a new firmware build, in one embodiment the firmware agent may add the firmware to the database. The firmware agent may get a copy of the firmware from the device manager, or the device manager may store a copy of the firmware in a repository 138 from which the agent may pull the firmware. For example a firmware developer may have a known interface or location from which new firmware may be retrieved by a firmware agent. It will be appreciated the device manager and firmware agent may communicate according to a protocol where, for example, the device manager may identify the firmware as being a new build, and authenticate with the firmware agent so the agent may decide, based at least in part on the identity of the firmware provider, that it should update the database with a copy of the new firmware. The protocol may include requests that the device manager and firmware agent might make to each other regarding sending, receiving, validating, etc. firmware as well as links to repositories such as repository 138 or other server that may maintain copies of firmware or other data associated with a device, device vendor, firmware developer(s), etc.

It will be appreciated communication may also include cryptographic components, such as digitally signing and/or encrypting firmware for delivery to the firmware agent so that the firmware agent can be assured it was not tampered with during delivery. Cryptographic communications may be based on either or both of cryptosystem keys associated with either the device manager and/or the firmware agent. It will be appreciated a firmware may be considered to be a single data chunk, or it may be represented through multiple parts each of which might be separately communicated to the firmware agent. Further, it will be appreciated it may be only one portion of a firmware is deemed vulnerable and therefore only that part of the firmware might be stored or updated in the database. Not illustrated in the database are other characteristics that one skilled in the art will appreciated may be associated with entries in the database, such as firmware vendor, date, reputation or trust data, time stamps, etc. In one embodiment, a signature from a device manager 106/developer of the device 102 may be a unique number, such as a GUID (Globally Unique Identifier). It will be appreciated while a GUID is unique for practical purposes, if it is generated based on various inputs, such as the firmware or portion thereof, it is possible to have a duplicate GUID. In the event of a duplicate, other characteristics associated with a firmware may be used to disambiguate apparent duplicates. As noted above the signature(s) may also include a value (e.g., determined by the firmware agent) that may operate, as will be discussed further below, as a virus signature to identify rogue code.

In one embodiment, the firmware agent 116 has multiple components, including a firmware signature management component 140 to determine or validate a signature 124 for a firmware 122, as well as to store and retrieve firmware into and out of the database 118, along with associated information 126 such as whether it is currently considered good or bad. The firmware agent may also have a manageability engine (ME) agent component 142 that may communicate, such as through data channel 114 (e.g., the Internet, or other network), with a device manager 106 to coordinate the communication regarding firmware identification (e.g., obtaining a signature for a device's firmware from its device manager), evaluation for firmware vulnerabilities, as well as to coordinate updating firmware if needed.

The firmware agent 116 may also include a firmware vulnerability management component 144 that, once a new firmware vulnerability is identified, this component adds the vulnerability signature to the database, and as illustrated, may also store a copy of the impacted firmware 122. In one embodiment, the signature that is stored is the signature provided by the device manager to identify the firmware. In another embodiment, the signature 124 in the database is a vulnerability signature, and this is an identifier determined by the firmware agent to track vulnerable firmware (or portions of a firmware) and may be used to identify when a firmware is vulnerable. The firmware agent may store its vulnerability signature separately from the signature from the device manager. Thus, either the device manager provided signature may be used to identify a specific firmware, and when determined to be vulnerable it and its signature may be stored in the database. Or, a separate vulnerability signature determined by the firmware agent may be used to identify vulnerable firmware or portions thereof.

The firmware agent 116 may also have a firmware vulnerability scanner 146. As discussed, a signature for bad firmware may be maintained, for example, in the database 118. As noted above, in some embodiments, the scanner may operate somewhat akin to a virus scanner, to inspect firmware for matches with a vulnerability signature against a firmware or portion thereof. It will be appreciated in one embodiment, the firmware being inspected may be provided by a device manager 106 in response to a request from the firmware agent 116. Or it will be appreciated existing firmware in the database (or repository 138) may be inspected, and the inspected firmware may be one in use by the device 102. Thus it will be appreciated that a firmware review may be initiated by a device, or by the firmware agent, and actual firmware on a device may be inspected, or a copy stored in the database or repository inspected and the device managed appropriately depending on the results of investigation. Further, it will be appreciated that a firmware agent may regularly review firmware located in the database or repository and, if a vulnerability is found, then devices using the firmware may be contacted and updated as discussed above, e.g., in accord with device policy, user preferences, etc. And the firmware may review firmware when new firmware is developed or existing firmware (or a portion thereof) is updated. It will be appreciated these are just a few examples of a firmware agent reviewing firmware.

In one embodiment, let's assume the firmware agent 116 collects firmware, e.g., firmware 104. As discussed above it may be obtained from a variety of sources, such as directly from a developer, from a repository 138, from already within the database 118, or elsewhere. The firmware agent then tests firmware out of band (00B) for vulnerabilities, e.g., in parallel to production/use of firmware. If the firmware agent detects a new vulnerability with vulnerability scanner 146, this “bad” firmware may be recorded in the database. The vulnerability scanner may also check whether a device 102 is using a firmware with a detected vulnerability. It will be appreciated knowledge of which firmware a device is using may be stored in the database. Also, when one vulnerability is detected, affected firmware may be used to locate other firmware that may have corresponding vulnerabilities. In one embodiment, when a vulnerability is detected, the firmware agent may contact a device, or firmware developer, to determine firmware versions in use, e.g., the firmware agent may send a request to the device for its firmware information and/or signature to determine if a specific device is at risk. In one embodiment, the ME Agent 142 may contact the device manager 106 to report a vulnerable firmware and coordinate updating the device. It will be appreciated there are multiple opportunities for updating a vulnerable firmware, such as the ME agent pushing a good firmware to the device, the device manager being instructed to pull a good copy of the firmware from the server 112 or repository 138 or other resource. In one embodiment a firmware has an identifier (not illustrated) for a point of contact for a vulnerable firmware, where the firmware agent may report a vulnerability to the point of contact and the point of contact then contacts various devices to determine which are impacted. In another embodiment, a device automatically periodically checks for alerts, such as firmware concerns.

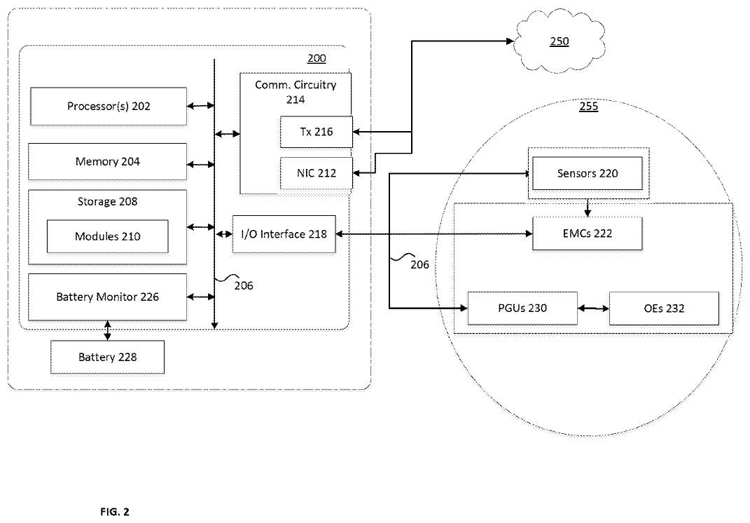

FIG. 2 illustrates an exemplary environment illustrating a computer device 200, in accordance with various embodiments. The computer device 200 may include any combinations of the components shown FIG. 2. The components may be implemented as integrated circuits (ICs) or portions thereof, discrete electronic devices, or other modules, logic, hardware, software, firmware, middleware or a combination thereof adapted in the computer device, or as components otherwise incorporated within a chassis of a larger system.

The computer device 200 may be an embedded system or any other type of computer device discussed herein. In one example, the computer device may be employed in or as a device providing sensors and sensor data as discussed herein. In another example, the computer device may be an aggregator in communication with sensors sharing sensed data. The sensors and aggregators may be separate and dedicated and/or special-purpose computer device designed specifically to carry out embodiments discussed herein.

Processor(s) 202 (also referred to as “processor circuitry”) may be one or more processing elements configured to perform basic arithmetical, logical, and input/output operations by carrying out instructions. Processor circuitry may be implemented as a standalone system/device/package or as part of an existing system/device/package of, for example, the FIG. 1 device 102, or server 112. The processor circuitry may be one or more microprocessors, one or more single-core processors, one or more multi-core processors, one or more multithreaded processors, one or more GPUs, one or more ultra-low voltage processors, one or more embedded processors, one or more DSPs, one or more FPDs (hardware accelerators) such as FPGAs, structured ASICs, programmable SoCs (PSoCs), etc., and/or other processor or processing/controlling circuit. The processor circuitry may be a part of a system on a chip (SoC) in which the processor circuitry and other components discussed herein are formed into a single IC or a single package. As examples, the processor circuitry may include one or more Intel Pentium®, Core®, Xeon®, Atom®, or Core M® processor(s); Advanced Micro Devices (AMD) Accelerated Processing Units (APUs), Epyc®, or Ryzen® processors; Apple Inc. A series, S series, W series, etc. processor(s); Qualcomm Snapdragon® processor(s); Samsung Exynos® processor(s); and/or the like.

In embodiments, the processor circuitry 202 may include a sensor hub (not illustrated), which may act as a coprocessor by processing data obtained from the sensors 220. The sensor hub may include circuitry configured to integrate data obtained from each of the sensors by performing arithmetical, logical, and input/output operations. In embodiments, the sensor hub may capable of timestamping obtained sensor data, providing sensor data to the processor circuitry in response to a query for such data, buffering sensor data, continuously streaming sensor data to the processor circuitry including independent streams for each sensor, reporting sensor data based upon predefined thresholds or conditions/triggers, and/or other like data processing functions.

Memory 204 (also referred to as “memory circuitry” or the like) may be circuitry configured to store data or logic for operating the computer device 200. Memory circuitry may include number of memory devices may be used to provide for a given amount of system memory. As examples, the memory circuitry can be any suitable type, number and/or combination of volatile memory devices (e.g., random access memory (RAM), dynamic RAM (DRAM), static RAM (SAM), etc.) and/or non-volatile memory devices (e.g., read-only memory (ROM), erasable programmable read-only memory (EPROM), electrically erasable programmable read-only memory (EEPROM), flash memory, antifuses, etc.) that may be configured in any suitable implementation as are known. In one embodiment, memory, such as flash memory or other memory is or may include a memory device that is a block addressable memory device, such as those based on NAND or NOR technologies. A memory device may also include future generation nonvolatile devices, such as a three dimensional crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In various implementations, individual memory devices may be formed of any number of different package types, such as single die package (SDP), dual die package (DDP) or quad die package (Q17P), dual inline memory modules (DIMMs) such as microDlMMs or MiniDIMMs, and/or any other like memory devices. To provide for persistent storage of information such as data, applications, operating systems and so forth, the memory circuitry may include one or more mass-storage devices, such as a solid state disk drive (SSDD); flash memory cards, such as SD cards, microSD cards, xD picture cards, and the like, and USB flash drives; on-die memory or registers associated with the processor circuitry 202 (for example, in low power implementations); a micro hard disk drive (HDD); three dimensional cross-point (3D XPOINT) memories from Intel® and Micron®, etc.

Where FPDs are used, the processor circuitry 202 and memory circuitry 204 (and/or device storage circuitry 208) may comprise logic blocks or logic fabric, memory cells, input/output (I/O) blocks, and other interconnected resources that may be programmed to perform various functions of the example embodiments discussed herein. The memory cells may be used to store data in lookup-tables (LUTs) that are used by the processor circuitry to implement various logic functions. The memory cells may include any combination of various levels of memory/storage including, but not limited to, EPROM, EEPROM, flash memory, SRAM, anti-fuses, etc.

Data storage circuitry 208 (also referred to as “storage circuitry” or the like), with shared or respective controllers, may provide for persistent storage of information such as modules 210, operating systems, etc. The storage circuitry may be implemented as solid state drives (SSDs); solid state disk drive (SSDD); serial AT attachment (SATA) storage devices (e.g., SATA SSDs); flash drives; flash memory cards, such as SD cards, microSD cards, xD picture cards, and the like, and USB flash drives; three-dimensional cross-point (3D Xpoint) memory devices; on-die memory or registers associated with the processor circuitry 202; hard disk drives (HDDs); micro HDDs; resistance change memories; phase change memories; holographic memories; or chemical memories; among others. As shown, the storage circuitry is included in the computer device 200; however, in other embodiments, storage circuitry may be implemented as one or more separate devices that are mounted in, for example, a server 112 or repository 138 separate from the other elements of the computer device.

In some embodiments, the storage circuitry 208 may include an operating system (OS) (not shown), which may be a general purpose operating system or an operating system specifically written for and tailored to the computer device 200. The OS may include one or more drivers, libraries, and/or application programming interfaces (APIs), which provide program code and/or software components for modules 210 and/or control system configurations to control and/or obtain/process data from one or more sensors 220 and/or EMCs 222. The modules 210 may be software modules/components used to perform various functions of the computer device and/or to carry out functions of the example embodiments discussed herein. In embodiments where the processor circuitry 202 and memory circuitry 204 includes hardware accelerators (e.g., FPGA cells) as well as processor cores, the hardware accelerators (e.g., the FPGA cells) may be pre-configured (e.g., with appropriate bit streams, logic blocks/fabric, etc.) with the logic to perform some functions of the embodiments herein (in lieu of employment of programming instructions to be executed by the processor core(s)). For example, the modules may comprise logic for the corresponding entities discussed with regard to FIG. 1.

The components of computer device 200 and/or FIG. 1 device 102, server 112, and repository 138 may communicate with one another over the bus 206. The bus may include any number of technologies, such as a Local Interconnect Network (LIN); industry standard architecture (ISA); extended ISA (EISA); PCI; PCI extended (PCIx); PCIe; an Inter-Integrated Circuit (I2C) bus; a Parallel Small Computer System Interface (SPI) bus; Common Application Programming Interface (CAPI); point to point interfaces; a power bus; a proprietary bus, for example, Intel® Ultra Path Interface (UPI), Intel® Accelerator Link (IAL), or some other proprietary bus used in a SoC based interface; or any number of other technologies. In some embodiments, bus 206 may be a controller area network (CAN) bus system, a Time-Trigger Protocol (TTP) system, or a FlexRay system, which may allow various devices (e.g., sensors 220, EMCs 222, etc.) to communicate with one another using messages or frames. Communications circuitry 214 may include circuitry for communicating with a wireless network or wired network. For example, the communication circuitry may include transceiver (Tx) 216 and network interface controller (NIC) 212, and may include one or more processors (e.g., baseband processors, modems, etc.) dedicated to a particular wireless communication protocol.

NIC 212 may be included to provide a wired communication link to a network 250, e.g., the cloud, and/or other devices. Wired communication may provide an Ethernet connection, an Ethernet-over-USB, and/or the like, or may be based on other types of networks, such as DeviceNet, ControlNet, Data Highway+, PROFIBUS, or PROFINET, among many others. An additional NIC may be included to allow connection with a second network (not shown) or other devices, for example, a first NIC 212 providing communications to the network 250 over Ethernet, and a second NIC providing communications to other devices over another type of network, such as a personal area network (PAN) including a personal computer (PC) device. In some embodiments, the various illustrated components, such as sensors 220, EMCs 222, PGUs 230, etc. may be connected to the system 200 via the NIC 212 as discussed above rather than via the I/O circuitry 218.

The Tx 216 may include one or more radios to wirelessly communicate with the network 250 and/or other devices. The Tx may include hardware devices that enable communication with wired networks and/or other devices using modulated electromagnetic radiation through a solid or non-solid medium. Such hardware devices may include switches, filters, amplifiers, antenna elements, and the like to facilitate the communications over the air (OTA) by generating or otherwise producing radio waves to transmit data to one or more other devices, and converting received signals into usable information, such as digital data, which may be provided to one or more other components of computer device 200. In some embodiments, the various components of the illustrated embodiment, such as sensors 220, EMCs 222, PGUs 230, etc. may be connected to the system 200 via the Tx as discussed above rather than via the I/O circuitry 218. In one example, one or more sensors 220 may be coupled with system 200 via a short range communication protocol, such as BLE or the like. In another example, the PGUs may be coupled with the system via a wireless connection (e.g., via Tx or the like) and operate in conjunction with one or more remote display protocols, such as the wireless gigabit alliance (WiGiG) protocol, the remote desktop protocol (RDP), PC-over-IP (PCoIP) protocol, the high-definition experience (HDX) protocol, and/or other like remote display protocols.

The Tx 216 may include one or multiple radios that are compatible with any number of 3GPP (Third Generation Partnership Project) specifications, notably Long Term Evolution (LTE), Long Term Evolution-Advanced (LTE-A), Long Term Evolution-Advanced Pro (LTE-A Pro), and Fifth Generation (5G) New Radio (NR). It can be noted that radios compatible with any number of other fixed, mobile, or satellite communication technologies and standards may be selected. These may include, for example, any Cellular Wide Area radio communication technology, which may include e.g. a 5G communication systems, a Global System for Mobile Communications (GSM) radio communication technology, a General Packet Radio Service (GPRS) radio communication technology, or an Enhanced Data Rates for GSM Evolution (EDGE) radio communication technology. Other Third Generation Partnership Project (3GPP) radio communication technology that may be used includes UMTS (Universal Mobile Telecommunications System), FOMA (Freedom of Multimedia Access), 3GPP LTE (Long Term Evolution), 3GPP LTE Advanced (Long Term Evolution Advanced), 3GPP LTE Advanced Pro (Long Term Evolution Advanced Pro)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-SCDMA (Time Division-Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP LTE Extra, LTE Licensed-Assisted Access (LAA), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Wireless Gigabit Alliance (WiGig) standard, mmWave standards in general (wireless systems operating at 10-90 GHz and above such as WiGig, IEEE 802.11ad, IEEE 802.11ay, and the like. In addition to the standards listed above, any number of satellite uplink technologies may be used for the uplink transceiver, including, for example, radios compliant with standards issued by the ITU (International Telecommunication Union), or the ETSI (European Telecommunications Standards Institute), among others.

Communication circuitry 214 may implement or support any number of standards, protocols, and/or technologies datacenters typically use, such as networking technology providing high-speed low latency communication. For example, the communication chip(s) may support RoCE (Remote Direct Memory Access (RDMA) over Converged Ethernet), e.g., version 1 or 2, which is a routable protocol having efficient data transfers across a network, and is discussed for example at Internet URL RDMAconsortium.com. The chip(s) may support Fibre Channel over Ethernet (FCoE), iWARP, or other high-speed communication technology, see for example the OpenFabrics Enterprise Distribution (OFED™) documentation available at Internet URL OpenFabrics.org. It will be appreciated datacenter environments benefit from highly efficient networks, storage connectivity and scalability, e.g., Storage Area Networks (SANs), parallel computing using RDMA, Internet Wide Area Remote Protocol (iWARP), InfiniBand Architecture (IBA), and other such technology. The examples provided herein are thus understood as being applicable to various other communication technologies, both existing and not yet formulated. Implementations, components, and details of the aforementioned protocols may be those known in the art and are omitted herein for the sake of brevity.

The input/output (I/O) interface 218 may include circuitry, such as an external expansion bus (e.g., Universal Serial Bus (USB), FireWire, Thunderbolt, PCI/PCIe/PCIx, etc.), used to connect computer device 200 with external components/devices, such as sensors 220, EMCs 222, PGUs 230, etc. I/O interface circuitry 218 may include any suitable interface controllers and connectors to interconnect one or more of the processor circuitry 202, memory circuitry 204, data storage circuitry 208, communication circuitry 214, and the other components of computer device 200. The interface controllers may include, but are not limited to, memory controllers, storage controllers (e.g., redundant array of independent disk (RAID) controllers, baseboard management controllers (BMCs), input/output controllers, host controllers, etc. The connectors may include, for example, busses (e.g., bus 206), ports, slots, jumpers, interconnect modules, receptacles, modular connectors, etc. The I/O circuitry 218 may couple the system 200 with sensors 220, EMCs 222, PGUs 230, etc. via a wired connection, such as using USB, FireWire, Thunderbolt, RCA, a video graphics array (VGA), a digital visual interface (DVI) and/or mini-DVI, a high-definition multimedia interface (HDMI), an S-Video, and/or the like. Although FIG. 2 shows that the sensors 220, EMCs 222, and PGUs 230 are coupled with the computer device 200 via interface circuitry 218, in other embodiments, the sensors, EMCs 222, and PGUs may be communicatively coupled with the computer device via Tx 216, using short-range radio links, WiFi signaling, or the like.

Sensors 220 may operate as discussed above with respect to FIG. 1 sensors 108-114, 124, 128, and be any device configured to detect events or environmental changes, convert the detected events into electrical signals and/or digital data, and transmit/send the signals/data to the computer device 200 and/or one or more EMCs 222. Some of the sensors 220 may be sensors used for providing computer-generated sensory inputs in an environment which may include computer device 200. Some of the sensors may be sensors used for motion and/or object detection. Examples of such sensors may include, inter alia, charged-coupled devices (CCD), Complementary metal-oxide-semiconductor (CMOS) active pixel sensors (APS), lens-less image capture devices/cameras, thermographic (infrared) cameras, Light Imaging Detection And Ranging (LIDAR) systems, and/or the like. In some implementations, the sensors may include a lens-less image capture mechanism comprising an array of aperture elements, wherein light passing through the array of aperture elements define the pixels of an image. In embodiments, the motion detection sensors may be coupled with or associated with light generating devices, for example, one or more infrared projectors to project a grid of infrared light onto a scene or environment, where an infrared camera may record reflected infrared light to compute depth information.

Some of the sensors 220 may be used for position and/or orientation detection, ambient/environmental condition detection, and the like. Examples of such sensors may include, inter alia, microelectromechanical systems (MEMS) with piezoelectric, piezoresistive and/or capacitive components, which may be used to determine environmental conditions or location information related to the computer device 200. In embodiments, the MEMS may include 3-axis accelerometers, 3-axis gyroscopes, and/or magnetometers. In some embodiments, the sensors may also include one or more gravimeters, altimeters, barometers, proximity sensors (e.g., infrared radiation detector(s) and the like), depth sensors, ambient light sensors, thermal sensors (thermometers), ultrasonic transceivers, and/or the like.

The EMCs 222 may be devices that allow computer device 200 to change a state, position, orientation, move, and/or control a mechanism or system. The EMCs may include one or more switches; haptic output devices, such as actuators and/or motors (e.g., eccentric rotating mass (ERM) actuators, linear resonant actuator (LRA), piezoelectric actuators, servomechanisms, rotary motors, linear motors, and step motors, etc.), thrusters, projectile ejecting devices (e.g., using spring loaded or compressed air/fluid), and/or the like. In embodiments, the EMCs may comprise speakers, a digital rendering module(s) (e.g., a physical object with a digital rendering module therein), and/or another way to control an acoustic energy emission, an electromagnetic radiation emission, an electric energy application, a magnetic field, and an acceleration or deceleration emitted or experienced by a physical object. In embodiments, computer device may be configured to operate one or more EMCs by transmitting/sending instructions or control signals to the EMCs based on detected user interactions or other like events.

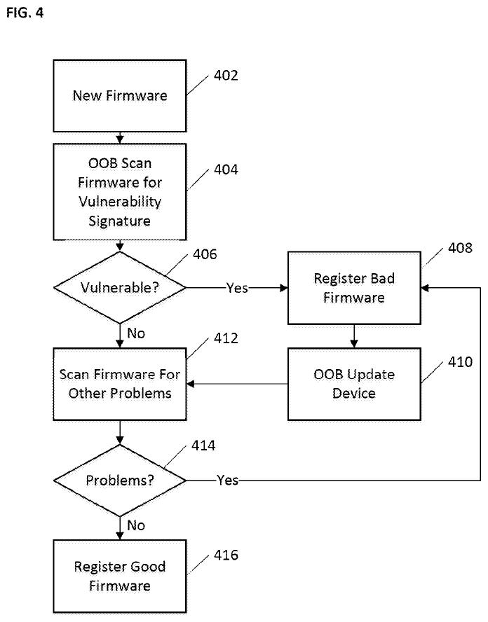

Picture generation units (PGUs) 230 may generate light (e.g., based on digital images), which may be directed and/or redirected to optical elements (OEs) 232, e.g., to a display surface. The digital images may be any type of content stored by the storage circuitry 208, streamed from remote devices via the communication circuitry 214, and/or based on outputs from various sensors 220, EMCs 222, and/or other objects, or, as discussed in FIG. 4, generated to assist with an emergency. The OE that combines the generated light with the external light may be referred to as a “combiner element”. The PGUs 230 may be one or more electronic devices that create or generate digital images to be directed to OEs 232. The combiner element (as well as other OEs) may be a display surface, which may be fully or partially opaque or transparent, that mixes the digital images output by the projector/PGUs 230 with viewed real-world objects to facilitate augmented reality. In embodiments, the OEs 232 may be a holographic OE, and in some embodiments, the combiner element may be a hologram or holographic image (e.g., transmissive, reflective, etc.).

The battery 228 may power the computer device 200. In embodiments, the battery may be a lithium ion battery, a metal-air battery, such as a zinc-air battery, an aluminum-air battery, a lithium-air battery, a lithium polymer battery, and the like. The battery monitor 226 may be included in the computer device 200 to track/monitor various parameters of the battery, such as a state of charge (SoCh) of the battery, state of health (SoH), and the state of function (SoF) of the battery. The battery monitor may include a battery monitoring IC, which may communicate battery information to the processor circuitry 202 over the bus 206. The bus may allow components of computer device 200 to communicate with one another. The bus may include any number of technologies, such as a Local Interconnect Network (LIN); industry standard architecture (ISA); extended ISA (EISA); Peripheral Component Interconnect Express (PCI); PCI extended (PCIx); PCI express (PCIe); an Inter-Integrated Circuit (I2C) bus; a Parallel Small Computer System Interface (SPI) bus; point to point interfaces; a power bus; a proprietary bus, for example, used in a SoC based interface; or any number of other technologies. Suitable implementations and general functionality of such bus systems are known, and are readily implemented by persons having ordinary skill in the art.

While not shown, various other devices may be present within, or connected to, the computer device 200. For example, I/O devices, such as a display, a touchscreen, or keypad may be connected to the computer device 200 via bus 206 to accept input and display outputs. In another example, the computer device may include or be coupled with positioning circuitry configured to determine coordinates based on signals received from global navigation satellite system (GLASS) constellations, e.g., to derive GPS data. In another example, the communications circuitry 214 may include a Universal Integrated Circuit Card (UICC), embedded UICC (eUICC), and/or other elements/components that may be used to communicate over one or more wireless networks.

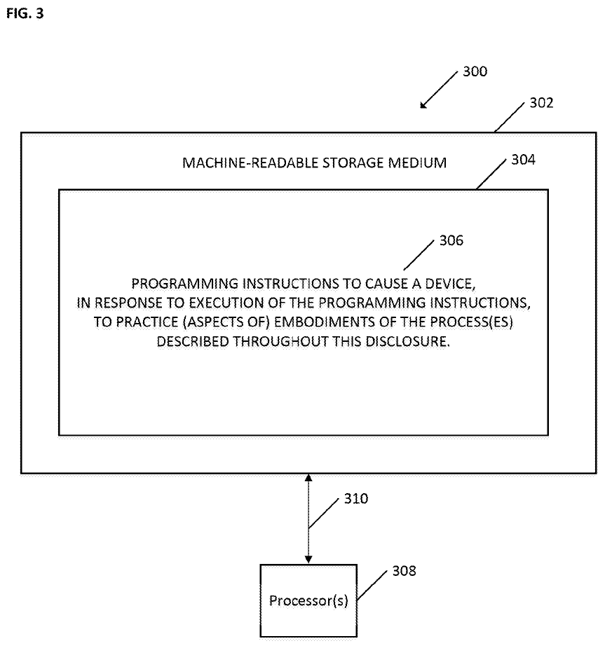

FIG. 3 illustrates an exemplary environment 300 illustrating a storage medium that may be transitory, non-transitory or a combination of transitory and non-transitory media, and the medium may be suitable for use to store instructions that cause an apparatus, machine or other device, in response to execution of the instructions, to practice selected aspects of the present disclosure. As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects. Furthermore, the present disclosure may take the form of a computer program product embodied in any tangible or non-transitory medium of expression having computer-usable program code embodied in the medium.

In one embodiment, the storage medium is a non-transitory, machine readable (or machine accessible) medium (NTMRM) 302 including associated information 304 that includes at least instructions 306 to direct one or more processor 308 to perform various functions delineated by the embodiments discussed herein. In embodiments, the non-transitory, machine readable medium 302 may be implemented in FIG. 1 device 102, server 112, and/or repository 136. The processor may access the non-transitory, machine readable medium 302 over a bus 310. The processor and bus may be the same or similar as described with respect to the processor 202 and bus 206 of FIG. 2. The non-transitory, machine readable medium may include devices described for the mass storage 208 of FIG. 2 or may include optical disks, thumb drives, or any number of other hardware devices or environments providing access to information. In alternate embodiments, machine readable medium may be transitory, e.g., signals.

The NTMRM 302 may include code to direct the processor 308 to obtain data from FIG. 1 device 102, server 112, and/or repository 136, as well as from FIG. 2 sensors 220. The sensor data may be representative of a physical environment. In one embodiment a modeling engine may direct the processor 308 to generate a model of the physical environment based at least in part on the sensor data. It will be appreciated the model need not be a visual-based model, and may just be various sensor input associated with positional data in any known spatial location system, e.g., longitude/latitude/altitude, 3-point (e.g., XYZ) positions, GPS (Global Positioning System) coordinates, triangulation based on communication towers, association with devices having a known location (e.g., printers, routers and other devices may have a known location that may be imputed to a device passing in range of it), etc. The model may be a suitable collection of data points in the multi-dimensional space connected by various geometric shapes or entities and may include textual and/or contextual information for various surfaces and/or locations within the environment. The model may be generated using any suitable modeling techniques/technologies.

The NTMRM may include code to receive and process user input and/or data associated with an analysis engine to direct the processor to perform some action, such as obtain data from FIG. 1 device 102, server 112, and/or repository 136, or FIG. 2 sensors 220, interpret user interactions such as gestures and/or speech, interact with other hardware, etc. In some embodiments, sensor and/or other data processed by the processor may include sensor data obtained from wearable technology which may be used to augment or supplement sensor data. In some embodiments, the NTMRM may include code to direct an aggregator to receive and evaluate sensor data and to instantiate virtual sensors and/or derive new virtual sensors based on received sensor data, and to recognize and respond to emergency situations.

The NTMRM may include code of a semantic engine (not illustrated) to direct the processor 302 to determine one or more semantic attributes, which may be used to influence operation of devices executing the code. The semantic engine may determine aspects such as user activity, user attributes, semantic location, social circumstances, ambient or environmental conditions, presence of electronic devices, schedules, communication, etc. that may allow determining what are desirable actions in a given circumstance. User activity semantics may include any information related to user, such as body (or body part) positions or orientations. User attributes may include any information related to user or user preferences.

It will be appreciated any combination of machine readable medium may be utilized, including, for example, but not limited to, an electronic, magnetic, optical, electromagnetic, infrared, or semiconductor system, apparatus, device, or propagation medium. More specific examples (a non-exhaustive list) of the machine readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or machine readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this disclosure, a computer-usable or machine readable medium may be any medium that can contain, store, communicate, propagate, or transport the program for use by or in connection with the instruction execution system, apparatus, or device. The machine readable medium may include a propagated data signal with the computer-usable program code embodied therewith, either in baseband or as part of a carrier wave. The computer usable program code may be transmitted using any appropriate wired or wireless medium.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Cooperative program execution may be for a fee based on a commercial transaction, such as a negotiated rate (offer/accept) arrangement, established and/or customary rates, and may include micropayments between device(s) cooperatively executing the program or storing and/or managing associated data.

FIG. 4 illustrates an exemplary environment 400 including a flowchart for handling, according to one embodiment, creation of a new firmware 402. In this embodiment, it is assumed there is a firmware vulnerability database managed by a firmware agent as discussed with respect to FIG. 1. As illustrated, a firmware may be scanned 404 for vulnerabilities. This scan may occur out of band (00B) to operation of any particular device, and the scanning may occur within the device, by an external agent such as the firmware agent reviewing the device, or under the direction of a firmware agent reviewing another source for a firmware, such as a local database 118, repository 138, etc. In this embodiment, like a virus signature, it is assumed there may be a vulnerability signature that corresponds to problems identified with a firmware (or portion thereof). Firmware may be scanned and like a virus signature matching against a virus infected file, if 406 there is a match with a vulnerability signature, action should be taken to address the issue. By performing the scan OOB, a device is able to continue operation and need only be interrupted if there is a problem to be addressed.

As illustrated, if there is a vulnerability match, one response may be to register 408 the firmware as bad with a firmware agent, which as discussed above with respect to FIG. 1 may include storing a copy of the firmware in a database, and storing the vulnerability signature and/or signature of the firmware from the firmware developer. After the firmware is registered as having a vulnerability, the firmware agent may initiate an update 410 to the firmware. The update may occur OOB, for example, by notifying a device that it is running vulnerable firmware and in response a device manager for the device may pull an updated firmware that is good, e.g., it may get one from the firmware agent, or directly from a repository or other source. Alternatively, a ME agent 142 may instead push a good firmware to the device, where a device manager receives the firmware and installs it in the device. The ME agent may retrieve the good firmware from a database or other storage containing good firmware, or from a repository, or other source. The identification of a vulnerability and updating a device may occur as out of band operations to the normal operation of a device. In one embodiment, the state of the device is preserved so that if a critical vulnerability is identified, device operation is frozen, and underlying firmware replaced, and then device operation is resumed.

It will be appreciated after updating the firmware, the firmware may also be scanned 412 (or monitored) out of band (OOB) for other problems, such as potentially unwanted/program operation. Scanning may be performed on the device, remotely by an external entity such as a firmware agent 116, or some combination of both. This scan would allow catching new vulnerabilities that have not been formally recognized with a vulnerability signature, as well as to catch problems that a new firmware might introduce into a device, e.g. inadvertent incompatibilities. A test may be performed to determine if 414 there were other problems, such as may occur after updating. If no, then the current firmware could be registered 416, e.g., with a firmware agent, as good. As discussed in FIG. 1 the firmware and/or device manager derived signature and/or firmware agent vulnerability signature may be stored in a database to allow reviewing and comparing the new firmware with other firmware associated with the database or with firmware in a new device. In the illustrated embodiment, if 414 there are problems in one embodiment, processing loops back to registering the now-current firmware as bad, and performing another update 410. It will be appreciated other operations not illustrated may be performed, such as simply marking the firmware with a status indicating potentially unwanted program (PUP) events, or if another firmware is not available, marking it with a status indicating a need for an update, with notification to interested entities such as a developer, which may then result in another new firmware 402 being developed that may then be evaluated.

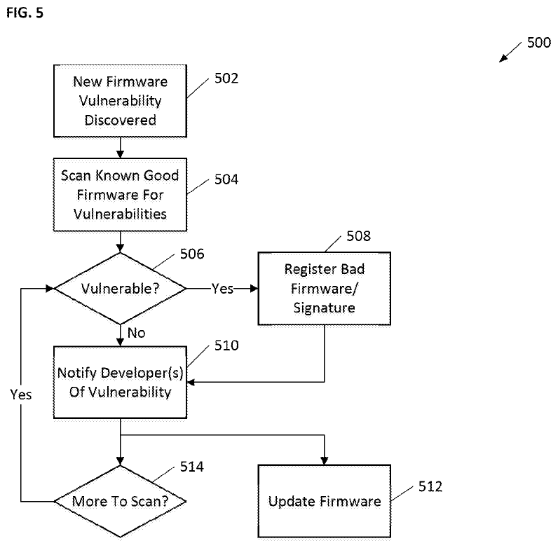

FIG. 5 illustrates an exemplary environment 500 illustrating a flowchart according to one embodiment for when a new vulnerability is found. As illustrated, after a new vulnerability is found 502, this raises the question of whether other known firmware may have the same or similar vulnerability. Therefore, in this embodiment, existing currently presumed good firmware are scanned 504 for vulnerabilities. As discussed above with respect to FIG. 1 and FIG. 4, there are a variety of options for scanning firmware, and in the illustrated embodiment it is assumed a firmware agent 116 has components 140-146 which assist with scanning a database 118 with entries 128-134 storing, among other things, firmware 122 with associated signature(s) 124 and an indication 126 of whether a firmware is considered to be good or bad. The database firmware entries currently having a good status may be scanned for vulnerabilities.

If 506 a firmware is found to be vulnerable, then firmware is registered 508 with the database as being bad, e.g., the database entry for the firmware is updated to have an indication 126 that the firmware is vulnerable. The firmware developer may then be notified 510 of the vulnerability, and the developer may then update 512 the firmware to address the vulnerability. Also, if 510 there are more firmware to scan and validate, processing may loop back to scanning 504 the next firmware for vulnerabilities. It will be appreciated that “bad” firmware may also be scanned to identify new vulnerabilities.

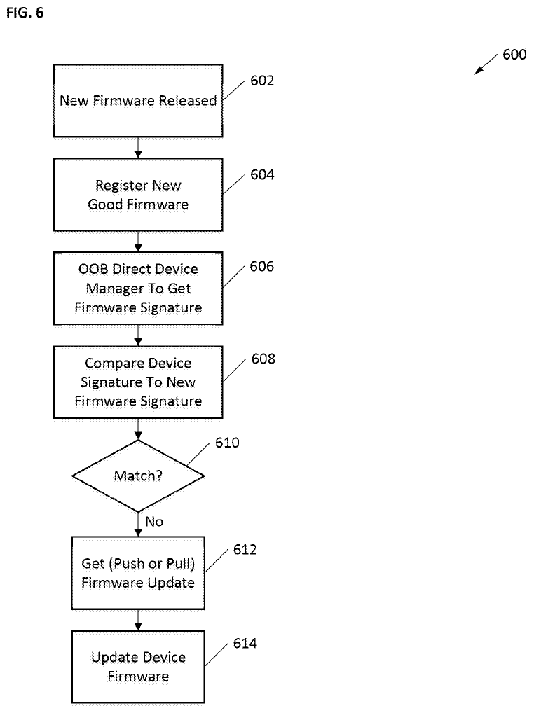

FIG. 6 illustrates an exemplary environment 600 illustrating a flowchart according to one embodiment for when there is a new firmware released, such as to overcome a known vulnerability. As illustrated after a vulnerability is discovered, a new firmware will be released 602 by a firmware vendor. Although there is a new firmware, as discussed above, if we have to rely on users to update their devices, this might not happen within a reasonable timeframe, if ever. Therefore, after fixing a vulnerability, the new good firmware is registered 604, and devices using earlier and/or related firmware are directed to get a firmware signature for their firmware. As discussed above the firmware vendor/device manager may determine a GUID signature identifying its firmware, it may be precomputed or dynamically determined. In the illustrated embodiment, getting the signature is an 00B request to the device manager. The firmware GUID allows a device manager, firmware agent, etc. to identify which firmware is on a device and hence determine if it has a vulnerability based at least in part on a previous vulnerability scan.

The device manager may then compare 606 its device's signature with a signature for the new firmware that was released. If 610 there is no match, meaning the device's firmware is not the new firmware that was released, then the device's firmware may be updated 612 which as discussed above with respect to FIG. 1 may be by way of the device pulling a new firmware copy from the firmware agent or a repository, of by the firmware agent pushing a new firmware to the device. Once the device has the new firmware it may be updated 614 to remove the vulnerability. It will be appreciated firmware may have multiple portions so that update a firmware may only require replace a portion of the firmware.

The present disclosure is described with reference to flowchart illustrations and/or block diagrams of methods, apparatus (systems) and computer program products according to embodiments of the disclosure. It will be understood each block of the flowchart illustrations and/or block diagrams, and combinations of blocks in the flowchart illustrations and/or block diagrams, may be implemented by computer program instructions. These computer program instructions, as discussed with respect to FIG. 3, may be provided to a processor of a general purpose computer, special purpose computer, or other programmable data processing apparatus to produce a machine, such that the instructions, which execute via the processor of the computer or other programmable data processing apparatus, provide for implementing the functions/acts specified in the flowchart and/or block diagram block or blocks.

Various aspects of the inventive embodiments may be appreciated in part through the following examples.

Example 1 may be a system for validating a firmware of a device based at least in part on data to be received over a network from a firmware agent that is communicatively coupled to a firmware vulnerability database and a device manager for the device, comprising the system to: determine a signature corresponding to at least a portion of the firmware before loading an operating system on the device; establish communication, through the network, with selected ones of the firmware agent or the device manager; determine a validity indicator for the firmware based at least in part on the signature; access, based at least in part on the validity indicator, an updated firmware for the device; and update the firmware of the device with the updated firmware.

Example 2 may be example 1, wherein the signature comprises a selected one or more of a GUID provided by the device manager, or a vulnerability signature provided by the firmware agent.

Example 3 may be example 1, wherein the signature is provided by the device manager to the firmware agent.

Example 4 may be example 3, wherein the validity indicator is based at least in part on a vulnerability signature determined by the firmware agent.

Example 5 may be example 1, wherein the signature is provided by the firmware agent, and the validity indicator is based at least in part on matching the signature against the firmware.

Example 6 may be example 1, the device having a boot process including loading an operating system, the system further comprising to: interrupt the boot process of the device; and electively load the operating system after a selected one or more of the receive the validity indicator, or the update the firmware.

Example 7 may be example 1, further comprising to: send the signature to the firmware agent; receive the validity indicator responsive to a vulnerability scan performed by the firmware agent of the firmware in use by the device; and push the updated firmware to the device.

Example 8 may be example 1, wherein the firmware agent is configured, in response to receiving the signature, to identify if the signature is a new signature, if new, to store a copy of the firmware in the vulnerability database, and perform out of band vulnerability scans of firmware associated with the vulnerability database.

Example 9 may be a method for validating a firmware of a device based at least in part on data to be received over a network from a firmware agent that is communicatively coupled to a firmware vulnerability database and a device manager for the device, comprising: determining a signature corresponding to at least a portion of the firmware before loading an operating system on the device; establishing communication, through the network, with selected ones of the firmware agent or the device manager; determining a validity indicator for the firmware based at least in part on the signature; accessing, based at least in part on the validity indicator, an updated firmware for the device; and updating the firmware of the device with the updated firmware.

Example 10 may be example 9, wherein the signature comprises a selected one or more of a GUID provided by the device manager, or a vulnerability signature provided by the firmware agent.

Example 11 may be example 9, wherein the signature is provided by the device manager to the firmware agent, and the validity indicator is based at least in part on a vulnerability signature determined by the firmware agent.

Example 12 may be example 9, wherein the signature is provided by the firmware agent, and the validity indicator is based at least in part on matching the signature against the firmware.

Example 13 may be example 9, further comprising: booting the device, the booting including loading an operating system; interrupting the boot process of the device; and electively loading the operating system after a selected one or more of receiving the validity indicator, or updating the firmware.

Example 14 may be example 9, further comprising: sending the signature to the firmware agent; receiving the validity indicator responsive to a vulnerability scan performed by the firmware agent of the firmware in use by the device; and pushing the updated firmware to the device.

Example 15 may be example 9, wherein the firmware agent is configured, in response to receiving the signature, to identify if the signature is a new signature, if new, to store a copy of the firmware in a database associated with the firmware agent, and perform out of band vulnerability scans of firmware associated with the database.

Example 16 may be example 9, further comprising: performing an out of band a scan of the firmware; determining the firmware has a vulnerability; setting the validity indicator to indicate a bad firmware; and recording the validity indicator in the vulnerability database.

Example 17 may be example 16, wherein the vulnerability is a potentially unwanted program operation.

Example 18 may be example 16, after the determining the vulnerability, the method further comprising: scanning firmware associated with the firmware database for other firmware with the vulnerability; and setting a status in the vulnerability database for the other firmware to the bad firmware validity indicator.

Example 19 may be example 9, in which the firmware is a new firmware, the method further comprising: performing an out of band a scan of the new firmware; creating an entry in the database for the new firmware; and recording the validity indicator in the vulnerability database.

Example 20 may be one or more non-transitory computer-readable media having instructions for validating a firmware of a device based at least in part on data to be received over a network from a firmware agent that is communicatively coupled to a firmware vulnerability database and a device manager for the device, the instructions, which when executed, provide for: determining a signature corresponding to at least a portion of the firmware before loading an operating system on the device; establishing communication, through the network, with selected ones of the firmware agent or the device manager; determining a validity indicator for the firmware based at least in part on the signature; accessing, based at least in part on the validity indicator, an updated firmware for the device; and updating the firmware of the device with the updated firmware.

Example 21 may be example 20, further having instructions for: booting the device, the booting including loading an operating system; interrupting the boot process of the device; and electively loading the operating system after a selected one or more of receiving the validity indicator, or updating the firmware.

Example 22 may be example 20, further having instructions for: sending the signature to the firmware agent; receiving the validity indicator responsive to a vulnerability scan performed by the firmware agent of the firmware in use by the device; and pushing the updated firmware to the device.

Example 23 may be example 20, further having instructions for: performing an out of band a scan of the firmware; determining the firmware has a vulnerability; setting the validity indicator to indicate a bad firmware; and recording the validity indicator in the vulnerability database.

Example 24 may be example 23, after the determining the vulnerability, having further instructions for: scanning firmware associated with the firmware database for other firmware with the vulnerability; and setting a status in the vulnerability database for the other firmware to the bad firmware validity indicator.

Example 25 may be example 20, further having instructions for: identifying the firmware as a new firmware; performing an out of band a scan of the new firmware; creating an entry in the database for the new firmware; and recording the validity indicator in the vulnerability database.

Example 26 may be any of examples 1-2, wherein the signature is provided by the device manager to the firmware agent.

Example 27 may be any of examples 1-4, wherein the signature is provided by the firmware agent, and the validity indicator is based at least in part on matching the signature against the firmware.

Example 28 may be any of examples 1-5, the device having a boot process including loading an operating system, the system further comprising to: interrupt the boot process of the device; and electively load the operating system after a selected one or more of the receive the validity indicator, or the update the firmware.

Example 29 may be any of examples 1-6, further comprising to: send the signature to the firmware agent; receive the validity indicator responsive to a vulnerability scan performed by the firmware agent of the firmware in use by the device; and push the updated firmware to the device.

Example 30 may be any of examples 1-7, wherein the firmware agent is configured, in response to receiving the signature, to identify if the signature is a new signature, if new, to store a copy of the firmware in the vulnerability database, and perform out of band vulnerability scans of firmware associated with the vulnerability database.

Example 31 may be a method for validating a firmware of a device based at least in part on data to be received over a network from a firmware agent that is communicatively coupled to a firmware vulnerability database and a device manager for the device, comprising: means for determining a signature corresponding to at least a portion of the firmware before loading an operating system on the device; means for establishing communication, through the network, with selected ones of the firmware agent or the device manager; means for determining a validity indicator for the firmware based at least in part on the signature; means for accessing, based at least in part on the validity indicator, an updated firmware for the device; and means for updating the firmware of the device with the updated firmware.

Example 32 may be example 31, further comprising: means for booting the device, the booting including loading an operating system; means for interrupting the boot process of the device; and means for electively loading the operating system after a selected one or more of receiving the validity indicator, or updating the firmware.

Example 33 may be example 31, further comprising: means for sending the signature to the firmware agent; means for receiving the validity indicator responsive to a vulnerability scan performed by the firmware agent of the firmware in use by the device; and means for pushing the updated firmware to the device.

Example 34 may be example 31, further comprising: means for performing an out of band a scan of the firmware; means for determining the firmware has a vulnerability; means for setting the validity indicator to indicate a bad firmware; and means for recording the validity indicator in the vulnerability database.

Example 35 may be example 34, after the determining the vulnerability, the method further comprising: means for scanning firmware associated with the firmware database for other firmware with the vulnerability; and means for setting a status in the vulnerability database for the other firmware to the bad firmware validity indicator.

Example 36 may be example 31, in which the firmware is a new firmware, the method further comprising: means for performing an out of band a scan of the new firmware; means for creating an entry in the database for the new firmware; and means for recording the validity indicator in the vulnerability database.

Example 37 may be any of examples 20-21, further having instructions for: sending the signature to the firmware agent; receiving the validity indicator responsive to a vulnerability scan performed by the firmware agent of the firmware in use by the device; and pushing the updated firmware to the device.

Example 38 may be any of examples 20-22, further having instructions for: performing an out of band a scan of the firmware; determining the firmware has a vulnerability; setting the validity indicator to indicate a bad firmware; and recording the validity indicator in the vulnerability database.

Example 39 may be any of examples 20-24, further having instructions for: identifying the firmware as a new firmware; performing an out of band a scan of the new firmware; creating an entry in the database for the new firmware; and recording the validity indicator in the vulnerability database.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A system for validating a firmware of a device based at least in part on data to be received over a network from a firmware agent that is communicatively coupled to a firmware vulnerability database and a device manager for the device, comprising the system to:
determine a signature corresponding to at least a portion of the firmware before loading an operating system on the device;
establish communication, through the network, with selected ones of the firmware agent or the device manager;
determine a validity indicator for the firmware based at least in part on the signature;
access, based at least in part on the validity indicator, an updated firmware for the device; and
update the firmware of the device with the updated firmware.

2. The system of claim 1, wherein the signature comprises a selected one or more of a GUID provided by the device manager, or a vulnerability signature provided by the firmware agent.

3. The system of any of claim 1, wherein the signature is provided by the device manager to the firmware agent.

4. The system of claim 3, wherein the validity indicator is based at least in part on a vulnerability signature determined by the firmware agent.

5. The system of any of claim 1, wherein the signature is provided by the firmware agent, and the validity indicator is based at least in part on matching the signature against the firmware.

6. The system of claim 1, the device having a boot process including loading an operating system, the system further comprising to:
interrupt the boot process of the device; and
electively load the operating system after a selected one or more of the receive the validity indicator, or the update the firmware.

7. The system of claim 1, further comprising to:
send the signature to the firmware agent;
receive the validity indicator responsive to a vulnerability scan performed by the firmware agent of the firmware in use by the device; and
push the updated firmware to the device.

8. The system of claim 1, wherein the firmware agent is configured, in response to receiving the signature, to identify if the signature is a new signature, if new, to store a copy of the firmware in the vulnerability database, and perform out of band vulnerability scans of firmware associated with the vulnerability database.

9. A method for validating a firmware of a device based at least in part on data to be received over a network from a firmware agent that is communicatively coupled to a firmware vulnerability database and a device manager for the device, comprising:
determining a signature corresponding to at least a portion of the firmware before loading an operating system on the device;
establishing communication, through the network, with selected ones of the firmware agent or the device manager;
determining a validity indicator for the firmware based at least in part on the signature;
accessing, based at least in part on the validity indicator, an updated firmware for the device; and
updating the firmware of the device with the updated firmware.

10. The method of claim 9, wherein the signature comprises a selected one or more of a GUID provided by the device manager, or a vulnerability signature provided by the firmware agent.

11. The method of claim 9, wherein the signature is provided by the device manager to the firmware agent, and the validity indicator is based at least in part on a vulnerability signature determined by the firmware agent.

12. The method of any of claim 9, wherein the signature is provided by the firmware agent, and the validity indicator is based at least in part on matching the signature against the firmware.

13. The method of claim 9, further comprising:
booting the device, the booting including loading an operating system;
interrupting the boot process of the device; and
electively loading the operating system after a selected one or more of receiving the validity indicator, or updating the firmware.

14. The method of claim 9, further comprising:
sending the signature to the firmware agent;
receiving the validity indicator responsive to a vulnerability scan performed by the firmware agent of the firmware in use by the device; and
pushing the updated firmware to the device.

15. The method of any of claim 14, wherein the firmware agent is configured, in response to receiving the signature, to identify if the signature is a new signature, if new, to store a copy of the firmware in a database associated with the firmware agent, and perform out of band vulnerability scans of firmware associated with the database.

16. The method of claim 9, further comprising:
performing an out of band a scan of the firmware;
determining the firmware has a vulnerability;
setting the validity indicator to indicate a bad firmware; and
recording the validity indicator in the vulnerability database.

17. The method of claim 16, wherein the vulnerability is a potentially unwanted program operation.

18. The method of claim 16, after the determining the vulnerability, the method further comprising:
scanning firmware associated with the firmware database for other firmware with the vulnerability; and
setting a status in the vulnerability database for the other firmware to the bad firmware validity indicator.

19. The method of claim 9, in which the firmware is a new firmware, the method further comprising:
performing an out of band a scan of the new firmware;
creating an entry in the database for the new firmware; and
recording the validity indicator in the vulnerability database.

20-25. (canceled)

26. One or more non-transitory computer-readable media having instructions for validating a firmware of a device based at least in part on data to be received over a network from a firmware agent that is communicatively coupled to a firmware vulnerability database and a device manager for the device, the instructions, which when executed, provide for:
determining a signature corresponding to at least a portion of the firmware before loading an operating system on the device;
establishing communication, through the network, with selected ones of the firmware agent or the device manager;
determining a validity indicator for the firmware based at least in part on the signature;
accessing, based at least in part on the validity indicator, an updated firmware for the device; and
updating the firmware of the device with the updated firmware.

27. The media of claim 26, further having instructions for:
booting the device, the booting including loading an operating system;
interrupting the boot process of the device; and
electively loading the operating system after a selected one or more of receiving the validity indicator, or updating the firmware.

28. The media of claim 26, further having instructions for:
sending the signature to the firmware agent;
receiving the validity indicator responsive to a vulnerability scan performed by the firmware agent of the firmware in use by the device; and
pushing the updated firmware to the device.

29. The media of claim 26, further having instructions for:
performing an out of band a scan of the firmware;
determining the firmware has a vulnerability;
setting the validity indicator to indicate a bad firmware; and
recording the validity indicator in the vulnerability database.

30. The media of claim 29, having further instructions for after the determining the vulnerability:
scanning firmware associated with the firmware database for other firmware with the vulnerability; and
setting a status in the vulnerability database for the other firmware to the bad firmware validity indicator.

31. The media of claim 26, further having instructions for:
identifying the firmware as a new firmware;
performing an out of band a scan of the new firmware;
creating an entry in the database for the new firmware; and
recording the validity indicator in the vulnerability database.
